(19) United States
(12) Patent Application Publication
(10) Pub. No.: US 2006/0165046 A1
(43) Pub. Date: Jul. 27, 2006

(54) Maintaining synchronization between a qos access point and qos stations in an ieee 802.11e wlan

(75) Inventor: Javier Del Prado Pavon, Ossining, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Phillps Electronics N.V.

(21) Appl. No.: 10/545,715

(22) PCT Filed: Feb. 9, 2004
(86) PCT No.: PCT/IB04/00329

§ 371 Date: Aug. 12, 2005

Related U.S. Application Data
(60) Provisional application No. 60/447,180, filed on Feb. 13, 2003.
(60) Provisional application No. 60/482,655, filed on Jun. 26, 2003.

(51) Int. Cl. H04J 3/06

(52) U.S. Cl. 370/350

(57) ABSTRACT

Disclosed is a method and system for maintaining synchronization of the Service Period between a quality of service capable access point (QAP) and a non-AP quality of service capable station (QSTA) in a parameterized quality of service (QoS) IEEE 802.11e wireless local area network (WLAN). A problem with loss of synchronization between QAP and non-AP QSTAs can occur on downlink for parameterized QoS if the acknowledgement (ACK) frame for the last downlink frame in the Service Period is not received by the QAP because the non-AP QSTA goes to sleep too soon.

The present invention relates to communication systems. More particularly, the present invention relates to a system and method for maintaining synchronization between an IEEE 802.11e quality of service capable (QoS-capable) access point (QAP) and non-AP QoS-capable stations (QSTAs), when the non-AP QSTAs are using the schedule element information to go into sleeping mode.

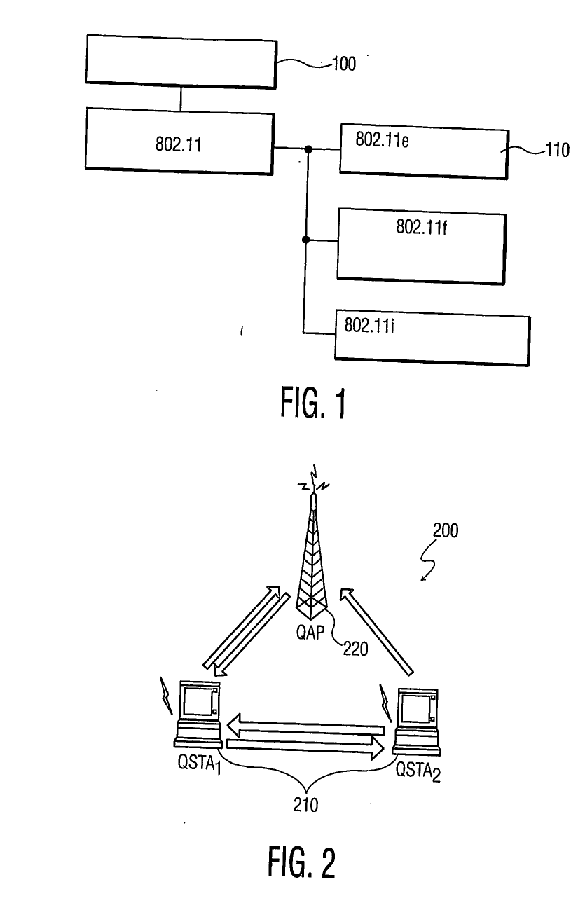

In general, referring to FIG. 1, the IEEE 802.11 wireless local area network (WLAN) standard includes the medium access control (MAC) sub-layer 100 of the Open System Interconnection OSI network reference model, which is hereby incorporated by reference. At the MAC layer, IEEE 802.11 e 110 delivers quality of service (QoS) support to an IEEE 802.11 WLAN. FIG. 2 illustrates an exemplary QoS basic service set (QBSS) WLAN 200 in which IEEE 802.11e MAC maintains QoS, however IEEE 802.11 WLAN was originally designed for best-effort services and a large number of proposals have been made for QoS enhancement schemes for 802.11 MAC. In FIG. 2 the QoS access point (QAP) 220 implements the access point functionality of the QoS facility of the IEEE 802.11e standard. A QoS basic service set (QBSS) is a basic service set 200, as illustrated in FIG. 2, that supports LAN applications by providing a QoS facility for communication via the wireless medium (WM) as specified in the IEEE 802.11e standard. A QoS station (QSTA) 210 is an IEEE 802.11 station (STA) that implements the QoS facility and hybrid coordination function (HCF), and includes and IEEE 702.11-comformant physical (PHY) interface to the wireless medium (WM).

The proposed or draft QoS enhancement schemes of an 802.11e wireless local area network (WLAN) can be characterized in several ways, including parameterized QoS. In general, QoS is the ability of a WLAN element to provide a given level of assurance of data delivery. Parameterized QoS is a strict QoS requirement that is expressed in terms of fixed quantitative values, such as data rate. These values are expected to be met within the MAC data service in the transfer of data frames between peer QSTAs.

In general, the Hybrid Coordinator (HC) establishes a Service Schedule for a non-AP QSTA. The Service Schedule is communicated to the non-AP QSTA in a Schedule element contained in an ADDTS response QoS Action message. The HC can update the Service Schedule at any time by sending a Schedule element in a Schedule QoS Action frame. The updated schedule is in effect when the HC receives the acknowledgement frame for the Schedule QoS Action frame.

A non-AP QSTA cannot directly reject a Service Schedule but can affect the Service Schedule by modifying or deleting its existing Traffic Specifications (TSPECs).

The Schedule element and protocol for parameterized QoS is defined in the IEEE 802.11e draft standard, IEEE 801.11 WG, Draft Supplement to Standard For Telecommunications and Information Exchange Between Systems-LAN/MAN Specific Requirements—Part 11: Wireless Medium Access Control (MAC) and physical layer (PHY) specifications: Medium Access Control (MAC) Enhancements for Quality of Service (QoS), IEEE 802.11E/Draft 4.0, November 2002, which is hereby incorporated by reference in its entirety. The Schedule element is transmitted from the QAP to the non-AP QSTAs to convey information regarding the QoS schedule assigned to the non-AP QSTA. This information includes time between Service Periods, duration of the Service Periods, and so on. This information can be used by the non-AP QSTA to save power and to go into sleeping mode when a Service Period is not scheduled.

However, the current mechanism defined in IEEE 802.11e can become unstable when one of the frames in lost during the Service Period. More specifically, the synchronization between QAP and non-AP QSTAs is lost if the acknowledgement (ACK) frame for the last downlink frame in the Service Period is not received by the QAP.

Accordingly, there is a need for a scheme for maintaining synchronization between an IEEE 802.112 QAP and non-AP QSTAs, when the non-AP QSTAs are using the Schedule element information to enter sleeping mode.

The present invention is directed to an approach which enables a non-AP QSTA to maintain synchronization with a QAP and determine when the non-AP QSTA can go to sleep mode.

According to an aspect of the present invention, if the last downlink data frame is not the single data frame during a Service Period, the non-AP QSTA responds with an ACK frame and remains awake for a distributed coordination function inter-frame space (DIFS) period thereafter and if no frame is received from the QAP during this period, the non-AP QSTA may go to sleep.

According to another aspect of the present invention, if the last downlink data frame is the first and single frame during a Service Period as scheme is provided for both the QAP and the non-AP QSTA to determine whether or not the Service Period started, and thus both are able to maintain synchronization.

A more complete understanding of the method and apparatus of the present invention may be had by reference to the following detailed description when taken in conjunction with the accompanying drawings wherein:

FIG. 1 illustrates the 802.11 MAC layer whereto embodiments of the present invention are to be applied;

FIG. 2 illustrates a communication system whereto embodiments of the present invention are to be applied;

FIG. 3 illustrates a simplified block diagram of a relevant part of a QoS-capable Access Point (QAP) and each non-AP QoS-capable station (QSTA) within a particular QoS basic service set (QBSS) according to an embodiment of the present invention;

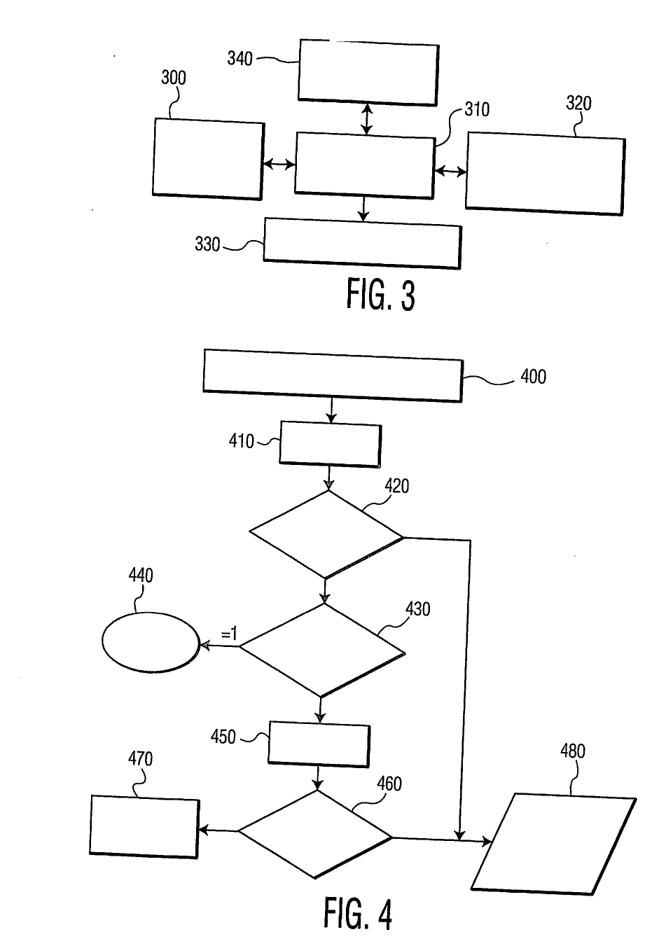

FIG. 4a is a flow chart illustrating the operation steps for maintaining synchronization when the last downlink data frame is not the single frame during the Service Period.

FIG. 4b is a flow chart illustrating the operations steps for maintaining synchronization when the last downlink data frame is also the first and single frame during the Service Period.

In the following description, by way of example and not limitation, particular details are provided for a thorough understanding of the present invention, e.g., QAP and QSTA architecture, 802.11e QoS procedures, that are relevant to the embodiments of the present invention. Other components have been omitted because they are well known to those of ordinary skill in the art and also for purposes of simplicity and clarity so as not to obscure the description of the present invention with unnecessary detail.

FIG. 1 illustrates the MAC layer of the 802.11e Specification to which embodiments of the present invention are to e applied.

FIG. 2 illustrates a representative network whereto embodiments of the present invention are to be applied. According to the principle of the present invention, there is provided a protocol for maintaining Service Period synchronization between the QAP and a non-AP QSTA. It should be noted that the network of FIG. 2 is small for the purpose of illustration. It should also be noted that in the basic 802.11 specification, traffic is only allowed between AP and STAs, i.e., STAs cannot send traffic to each other without connection with AP. 802.11e adds capability for QSTAs to send traffic directly to each other in the infrastructure mode, which significantly improves the bandwidth, especially in home networks.

The 802.11e draft standard specifies that power management in an infrastructure network be performed by the medium access control (MAC) sub-layer, see FIG. 1. In the IEEE 802.11e draft, the Schedule Element for parameterized QoS is transmitted from the QAP to the non-AP QSTAs in order to convey information regarding the QoS schedule assigned to the non-AP QSTAs. The non-AP QSTAs can use this information to save power and enter sleep mode when a Service Period is not scheduled.

In the IEEE 802.11e draft it is specified that a Service Period starts with a successful data or QoS (+)CF-Poll transmission by the Hybrid Coordinator (HC). The next Service Period starts no earlier than a Minimum Service Interval (as defined in the Schedule Element) after the last Service Period. During this time the non-AP QSTA can go to sleep mode, thus saving power.

The system and method of the present invention eliminate a problem that can appear in downlink Service Periods. It may happen that an ACK frame sent by a non-AP QSTA as a response to the last downlink data frame (which did not include piggyback poll) in a Service Period is lost (the last frame in the Service Period is indicated by the More Data flag being cleared). In this case, the non-AP QSTA assumes that the Service Period has ended, since it sent the ACK frame corresponding to the last frame in the Service Period, and therefore it may enter into sleep mode. However, the QAP assumes that the Service Period is still on-going since the last Data Frame was not correctly transmitted, and therefore may still retry. This situation can continue until the non-AP QSTA wakes up again.

The situation just described, worsens when there is a single downlink data transmission (with no piggyback poll). For example, the QAP starts a single downlink data transmission Service Period. If the non-AP QSTA receives the data frame correctly and transmits the ACK to the QAP, the non-AP QSTA assumes that the Service Period has started, and since is the single downlink frame, it also assumes that the Service Period has ended. Therefore, after sending the ACK frame the non-AP QSTA may go into sleep mode. However it can happen that the ACK is lost and therefore the QAP assumes that the Service Period didn't start. In this situation, the QAP may retransmit the data frame without success because the non-AP QSTA is in sleep mode. The non-AP QSTA will wake up a “Minimum Service Interval” period after it received the original downlink frame from the QAP. However, now the beginning of the last Service Period will differ in the QAP and non-AP QSTA, and therefore the synchronization between QAP and non-AP QSTA has been lost.

The system and method of the present invention provides two embodiments that solve this problem. Further, it should be noted that the problem just described only appears for downlink transmissions.

FIG. 3 is a simplified block diagram of an architecture which may be included in a QAP and each QSTAᵢ of the WLAN shown in FIG. 2. Both the QAP and each QSTAᵢ may include a memory 300, a CPU 310, a MAC sub-layer power management module 320, and a transmitter/receiver 330. Although the description may refer to terms commonly employed to describe specific computer systems, the description and concepts are meant to be equally applicable to other processing systems, including those having dissimilar architectures to that shown in FIG. 3. The transmitter/receiver is typically coupled to an antenna (not shown) to transmit and receive data. The CPU 310 is controlled by an operating system contained in the memory 300, accepts and delivers information to be transmitted and delivered from/to the information source/sink 340 by the transmitter/receiver 330, using the MAC synchronization management module 320 whereto embodiments of the present invention are applied to maintain synchronization of the beginning of a Service Period between a QAP and a non-AP QSTA.

Now, the principle of operation steps according to the present invention in maintaining synchronization between a QAP and a non-AP QSTA are explained hereafter.

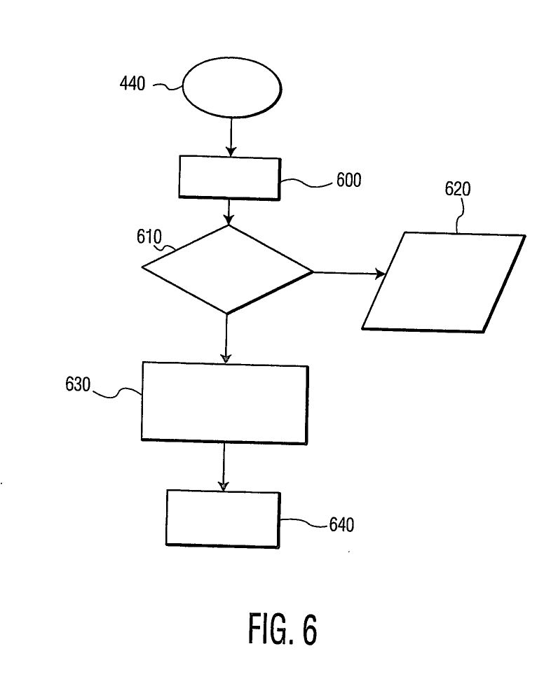

Referring now to FIG. 4, in a first preferred embodiment, the process at the non-AP QSTA is described. There are two possible cases; first the last downlink data frame is not the single frame during a Service Period (step 450); second the last downlink data frame is also the single frame during the Service Period (step 440 continued in FIG. 6). At step 400 the non-AP QSTA receives a downlink data frame and transmits an ACK at step 410. If, at step 420, the non-AP QSTA determines if the data frame received is the last downlinked data frame, as indicated by the More Data field being cleared and if not the non-AP QSTA continues normal processing at step 480. If the non-AP QSTA determines at step 420 that the More Data bit is cleared then the non-AP QSTA determines at step 430 if the last downlinked data frame is also the single frame during the Service Period and if so performs the second embodiment at step 440. If at step 430 the non-AP QSTA determines that the last downlinked data frame is not the single frame during the Service Period then at step 450 the non-AP QSTA waits a DIFS period of time after the ACK transmission is finished. If the non-AP QSTA did not start receiving a frame from the QAP during the DIFS period, it may go to sleep mode at step 470 for a succeeding Minimum Service Interval period.

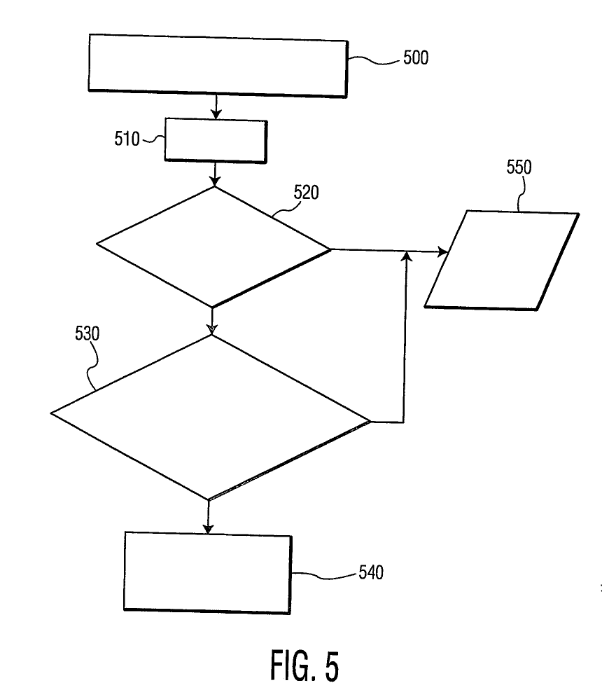

In a second preferred embodiment, the process at the QAP is described when the last downlink data frame is also the first and single frame during a Service Period. Referring now to FIG. 5, after sending the downlink data frame at step 500, at step 510 the QAP waits SIFS and at step 520 the QAP checks if PHY-CCA.indication(busy) occurred during the slot following short inter-frame space (SIFS) and if not continues normal QAP processing at step 550. If, at step 520, the QAP determines that PHY-CCA.indication(busy) occurred during the slot following short inter-frame space (SIFS) then the QAP check, at step 530, that PHY-CCA.indication(busy) was followed by PHY-RXSTART.indication or PHY-RXEND.indication prior to PHY-CCA.indication(idle), then at step 540 the QAP assumes that the downlink frame was successfully received by the non-AP QSTA (this is because it has started receiving a frame within a SIFS interval and can assume it is the ACK frame from the non-AP QSTA). Therefore, the QAP assumes that the Service Period started with the downlink frame. Otherwise, at step 550 the QAP assumes that the data frame was lost and the non-AP QSTA did not respond with the ACK frame, and therefore the Service Period didn't start.

Referring now to FIG. 4, after receiving the downlink data frame at step 400, as indicated by the More Data field being cleared, the non-AP QSTA responds with the ACK frame at step 410. At step 430 the non-AP QSTA then checks if the downlinked frame is the single frame in the Service Period and, if so, referring to FIG. 6, at step 600 remains awake during a DIFS period of time after the ACK transmission is finished. If, as checked at step 610, the non-AP QSTA does not receive a frame from the QAP during the DIFS period after the ACK transmission finished then the non-AP QSTA assumes that the QAP:

(a) received the ACK correctly, or

(b) the QAP decided not to retransmit.

In either case, both the QAP (at step 540 of FIG. 5) and the non-AP QSTA (at step 630 OF FIG. 6) assume that the Service Period started with the transmission of the downlink data frame, and hence the non-AP QSTA may go to sleep at step 630, after the DIFS period following the ACK transmission. Therefore, synchronization is maintained between the QAP and the non-AP QSTA.

Having thus described preferred embodiments of a QAP and non-AP QSTA synchronization maintenance scheme, it should be apparent to those ordinarily skilled in the art that certain advantages have been achieved. The foregoing is to be construed as only being illustrative embodiments of this invention. Persons skilled in the art can readily conceive of alternative arrangements that provide functionality similar to the described embodiments without deviating from the fundamental principles or the scope of this invention as embodied in the appended claims.

What is claimed is:

1. A method for maintaining synchronization of a Service Period between an access point (AP) and a station (STA) of a basic service set (BSS) in a wireless local area network (WLAN), comprising the steps of:
performed by the AP—
(a) transmitting a last downlink data frame to the STA, and
(b) determining if the Service Period started with the transmission of a last downlink data frame; and
performed by the STA—
(c) acknowledging receipt of the last downlink data frame from the AP, and
(d) determining if the Service Period started with the receipt of the last downlink data frame.

2. The method of claim 1, wherein the determining step (d) further comprises the steps of:
(d.1) waiting DIFS amount of time after performing the acknowledging step (c),
(d.2) after the wait of DIFS amount of time, optionally going into sleep mode if the STA has not started to receive a frame from the AP.

3. The method of claim 2, wherein the step (d.2) of optionally going into sleep mode further comprises the step of:
(d.2.1) remaining in sleep mode for a following Minimum Service Interval period.

4. The method of claim 2, further comprising the steps of:
when the last downlink data frame is the first and single data frame during the Service Period, the determining step (b) further comprises the steps of:
(b.1) waiting SIFS amount of time after transmitting the last downlink data frame;
(b.2) determining if the downlink frame was successfully received by the STA, and
(b.3) assuming the Service Period started if the last downlink frame transmitted is determined to be successfully received by the STA; and
(b.4) assuming that the Service Period did not start if the last downlink frame transmitted is not determined to be successfully received by the STA, i.e., it is lost.

5. The method of claim 4, wherein the step (d.2) of optionally going into sleep mode further comprises the step of:
(d.2.1) remaining in sleep mode for a following Minimum Service Interval period.

6. The method of claim 4, wherein the determining step (b.2) further comprises the steps of:
(b.2.1) determining that the downlink frame was successfully received by the STA if PHY-CCA.indication (busy) occurs during a slot following SIFS, followed by PHY-RXSTART.indication or PHY-RXEND.indication prior to PHY-CCA.indication(idle).

7. The method of claim 6, wherein the step (d.2) of optionally going into sleep mode further comprises the step of:
(d.2.1) remaining in sleep mode for a following Minimum Service Interval period.

8. The method of claim 1, further comprising the steps of:
when the last downlink data frame is the first and single data frame during the Service Period, the determining step (b) further comprises the steps of:
(b.1) waiting SIFS amount of time after transmitting the last downlink data frame;
(b.2) determining if the downlink frame was successfully received by the STA, and
(b.3) assuming the Service Period started if the last downlink frame transmitted is determined to be successfully received by the STA; and
(b.4) assuming that the Service Period did not start if the last downlink frame transmitted is not determined to be successfully received by the STA, i.e., it is lost.

9. The method of claim 8, wherein:
the step (a) of transmitting the last downlink data frame further comprises the step of—
(a.1) clearing the More Data field; and
the step (c) of acknowledging receipt of the last downlink data frame further comprises the step of—
(c.1) ascertaining that the More Data field is cleared.

10. The method of claim 9, wherein the determining step (b.2) further comprises the steps of:
(b.2.1) determining that the downlink frame was successfully received by the STA if PHY-CCA.indication (busy) occurs during a slot following SIFS, followed by PHY-RXSTART.indication or PHY-RXEND.indication prior to PHY-CCA.indication(idle).

11. The method of claim 10, wherein the WLAN is an IEEE 802.11e parameterized quality of service (QoS) basic service set (QBSS) WLAN, the AP is a QoS-capable AP (QAP) and the STA is a non-AP QoS-capable STA (QSTA).

12. The method of claim 7, wherein the WLAN is an IEEE 802.11e parameterized quality of service (QoS) basic service set (QBSS) WLAN, the AP is a QoS-capable AP (QAP) and the STA is a non-AP QoS-capable STA (QSTA).

13. The method of claim 1, wherein the WLAN is an IEEE 802.11e parameterized quality of service (QOS) basic service set (QBSS) WLAN, the AP is a QoS-capable AP (QAP) and the STA is a non-AP QoS-capable STA (QSTA).

14. A system having a station (STA) and an access point (AP) synchronization management subsystem for maintaining synchronization of a Service Period between an access point (AP) and a station (STA) of a basic service set (BSS) in a wireless local area network (WLAN), comprising:
(a) an AP synchronization management module for determining if the Service Period started with the transmission of a last downlink data frame; and
(b) a STA synchronization management module that determines if the Service Period starts with the transmission by the STA of an acknowledgement of receipt (ACK) of a last downlink data frame from the AP.

15. The system of claim 14, wherein the STA subsystem further comprises:
(b.1) a CPU, coupled to the STA synchronization management module for waiting a DIFS period of time after the ACK is sent and optionally putting the STA into sleep mode for a predetermined amount of time if the STA has not started to receive a frame from the AP within the DIFS amount of time.

16. The system of claim 15, wherein said predetermined amount of time is a Minimum Service Interval period following the DIFS period.

17. The system of claim 15, wherein the AP subsystem further comprises:
(a.1) a CPU coupled to said AP synchronization management module for, when the last downlink data frame is the first and single data frame sent during the Service Period, waiting a SIFS amount of time after transmission of the last downlink data frame; and then
(b.2) the CPU of the AP determines if the downlink frame was successfully received by the STA, and assumes one of—
i. the Service Period started if the last downlink frame transmitted was successfully received by the STA and
ii. the Service Period did not start if the last downlink frame transmitted was not successfully received by the STA, i.e., is lost.

18. The system of claim 17, wherein said predetermined amount of time is a Minimum Service Interval period following the DIFS period.

19. The system of claim 17, wherein the CPU of the AP determines if the downlink frame was successfully received by the STA as follows:
if PHY-CCA.indication(busy) occurs during a slot following SIFS, followed by PHY-RXSTART.indication or PHY-RXEND.indication prior to PHY-CCA.indication(idle).

20. The system of claim 15, wherein:
the AP synchronization management module clears the More Data field in the last downlink data frame; and
the STA synchronization management module ascertains that the last downlink data frame has been sent when the More Data field is cleared.

21. The system of claim 15, wherein the WLAN is an IEEE 802.11e parameterized quality of service (QoS) basic service set (QBSS) WLAN, the AP is a QoS-capable AP (QAP) and the STA is a non-AP QoS-capable STA (QSTA).

22. A method for maintaining synchronization of a Service Period between an access point (AP) and a station (STA) of a basic service set (BSS) in a wireless local area network (WLAN), comprising the steps of:
(a) the STA acknowledging receipt of the last downlink data frame from the AP, and
(b) the STA determining if the Service Period started with the receipt of the last downlink data frame.

23. The method of claim 22, wherein the determining step (b) further comprises the steps of:
(b.1) waiting DIFS amount of time after performing the acknowledging step (a),
(b.2) after the wait of DIFS amount of time, optionally going into sleep mode if the STA has not started to receive a frame from the AP.

24. The method of claim 23, wherein the step (b.2) of optionally going into sleep mode further comprises the step of:
(b.2.1) remaining in sleep mode for a following Minimum Service Interval period.

25. The method of claim 24, wherein the step (b.2) of optionally going into sleep mode further comprises the step of:
(b.2.1) remaining in sleep mode for a following Minimum Service Interval period.

26. The method of claim 25, wherein the step (b.2) of optionally going into sleep mode further comprises the step of:
(b.2.1) remaining in sleep mode for a following Minimum Service Interval period.

27. The method of claim 26, wherein the WLAN is an EEE 802.11e parameterized quality of service (QoS) basic service set (QBSS) WLAN, the AP is a QoS-capable AP (QAP) and the STA is a non-AP QoS-capable STA (QSTA).

28. The method of claim 22, wherein the WLAN is an IEEE 802.11e parameterized quality of service (QoS) basic service set (QBSS) WLAN, the AP is a QoS-capable AP (QAP) and the STA is a non-AP QoS-capable STA (QSTA).

29. A system having a station (STA) and an access point (AP) synchronization management subsystem for maintaining synchronization of a Service Period between an access point (AP) and a station (STA) of a basic service set (BSS) in a wireless local area network (WLAN), comprising
(a) a STA synchronization management module that determines if the Service Period starts with the transmission by the STA of an acknowledgement of receipt (ACK) of a last downlink data frame from the AP.

30. The system of claim 29, wherein the STA subsystem further comprises:
(a.1) a CPU, coupled to the STA synchronization management module for waiting a DIFS period of time after the ACK is sent and optionally putting the STA into sleep mode for a predetermined amount of time if the STA has not started to receive a frame from the AP within the DIFS amount of time.

31. The system of claim 29, wherein said predetermined amount of time is a Minimum Service Interval period following the DIFS period.

32. The system of claim 29, wherein:
the STA synchronization management module ascertains that the last downlink data frame has been sent when the More Data field is cleared.

33. The system of claim 29, wherein the WLAN is an IEEE 802.11e parameterized quality of service (QoS) basic service set (QBSS) WLAN, the AP is a QoS-capable AP (QAP) and the STA is a non-AP QoS-capable STA (QSTA).

34. A method for maintaining synchronization of a Service Period between an access point (AP) and a station (STA) of a basic service set (13SS) in a wireless local area network (WLAN), comprising the steps of:
(a) the AP transmitting a last downlink data frame to the STA, and
(b) the AP determining if the Service Period started with the transmission of a last downlink data frame.

35. The method of claim 34, further comprising the steps of:
when the last downlink data frame is the first and single data frame during the Service Period, the determining step (b) further comprises the steps of:
(b.1) waiting SIFS amount of time after transmitting the last downlink data frame;
(b.2) determining if the downlink frame was successfully received by the STA, and
(b.3) assuming the Service Period started if the last downlink frame transmitted is determined to be successfully received by the STA; and
(b.4) assuming that the Service Period did not start if the last downlink frame transmitted is not determined to be successfully received by the STA, i.e., it is lost.

36. The method of claim 34, wherein the determining step (b.2) further comprises the steps of:
(b.2.1) determining that the downlink frame was successfully received by the STA if PHY-CCA.indication (busy) occurs during a slot following SIFS, followed by PHY-RXSTART.indication or PHY-RXEND.indication prior to PHY-CCA.indication(idle).

37. The method of claim 34, further comprising the steps of:
when the last downlink data frame is the first and single data frame during the Service Period, the determining step (b) further comprises the steps of:
(b.1) waiting SIFS amount of time after transmitting the last downlink data frame;
(b.2) determining if the downlink frame was successfully received by the STA, and
(b.3) assuming the Service Period started if the last downlink frame transmitted is determined to be successfully received by the STA; and
(b.4) assuming that the Service Period did not start if the last downlink frame transmitted is not determined to be successfully received by the STA, i.e., it is lost.

38. The method of claim 37, wherein:
the step (a) of transmitting the last downlink data frame further comprises the step of—
(a.1) clearing the More Data field; and
the step (c) of acknowledging receipt of the last downlink data frame further comprises the step of—
(c.1) ascertaining that the More Data field is cleared.

39. The method of claim 38, wherein the determining step (b.2) further comprises the steps of:
(b.2.1) determining that the downlink frame was successfully received by the STA if PHY-CCA.indication (busy) occurs during a slot following SIFS, followed by PHY-RXSTART.indication or PHY-RXEND.indication prior to PHY-CCA.indication(idle).

40. The method of claim 39, wherein the WLAN is an IEEE 802.11e parameterized quality of service (QoS) basic service set (QBSS) WLAN, the AP is a QoS-capable AP (QAP) and the STA is a non-AP QoS-capable STA (QSTA).

41. The method of claim 34, wherein the WLAN is an IEEE 802.11e parameterized quality of service (QoS) basic service set (QBSS) WLAN, the AP is a QoS-capable AP (QAP) and the STA is a non-AP QoS-capable STA (QSTA).

42. A system having a station (STA) and an access point (AP) synchronization management subsystem for maintaining synchronization of a Service Period between an access point (AP) and a station (STA) of a basic service set (BSS) in a wireless local area network (WLAN), comprising:
(a) an AP synchronization management module for determining if the Service Period started with the transmission of a last downlink data frame.

43. The system of claim 42, wherein the AP subsystem further comprises:
(a.1) a CPU coupled to said AP synchronization management module for, when the last downlink data frame is the first and single data frame sent during the Service Period, waiting a SIFS amount of time after transmission of the last downlink data frame; and then
(b.2) the CPU of the AP determines if the downlink frame was successfully received by the STA, and assumes one of—
i. the Service Period started if the last downlink frame transmitted was successfully received by the STA and
ii. the Service Period did not start if the last downlink frame transmitted was not successfully received by the STA, i.e., is lost.

44. The system of claim 43, wherein said predetermined amount of time is a Minimum Service Interval period following the DIFS period.

45. The system of claim 43, wherein the CPU of the AP determines if the downlink frame was successfully received by the STA as follows:
if PHY-CCA.indication(busy) occurs during a slot following SIFS, followed by PHY-RXSTART.indication or PHY-RXEND.indication prior to PHY-CCA.indication(idle).

46. The system of claim 42, wherein:
the AP synchronization management module clears the More Data field in the last downlink data frame; and
the STA synchronization management module ascertains that the last downlink data frame has been sent when the More Data field is cleared.

47. The system of claim 42, wherein the WLAN is an IEEE 802.11e parameterized quality of service (QoS) basic service set (QBSS) WLAN, the AP is a QoS-capable AP (QAP) and the STA is a non-AP QoS-capable STA (QSTA).
